(19) United States
(12) Patent Application Publication
(10) Pub. No.: US 2016/0005505 A1
(43) Pub. Date: Jan. 7, 2016

(54) FLAME RETARDANT COMPOSITION COMPRISING A THERMOPLASTIC POLYETHERESTER ELASTOMER

(71) Applicant: DSM IP ASSETS B.V., Heerlen (NL)

(72) Inventors: Beert Jacobus KEESTRA, Echt (NL); Angelika SCHMIDT, Echt (NL)

(21) Appl. No.: 14/772,259

(22) PCT Filed: Feb. 20, 2014
(86) PCT No.: PCT/EP2014/053314

§ 371 Date: Sep. 2, 2015

(30) Foreign Application Priority Data
Mar. 6, 2013 (EP) 13157953.4

(51) Int. Cl. H01B 3/42

(52) U.S. Cl. CPC H01B 3/423

(57) ABSTRACT

A polymer composition comprising:—a thermoplastic copolyetherester elastomer comprising 40-65 wt. % of soft segments derived from poly(tetrahydrofuran)diol (pTHF), having a number average molecular weight (Mn) of between 1000 and 2500 kg/kmol.—at least 15 wt % of a metal hydrate,—at least 12.5 wt. % of an oligomeric phosphate ester.

The invention relates to a flame retardant composition comprising a thermoplastic copolyetherester elastomer. Such a composition is for example known from EP-2047482.

Also described therein are cables having an insulation produced of that composition. In this way a cable is provided that can withstand heavy flame retardancy tests, so that the cable is suitable for many applications where flame retardancy is important. It is also of interest that the composition and therefore also the insulation is free of halogens. This is contrary to cable insulations of plasticized PVC. A problem of the known composition however is the high price of the flame retardants used in the composition. This puts a limit to the application of the composition and for example many possibilities to replace plasticized PVC by the halogen free composition are not practiced, because of the high price.

Object of the invention is to provide a halogen free, flame retardant composition that is less costly, but that gives nevertheless a good flame retardancy. Surprisingly this object is achieved by a composition comprising:
a thermoplastic copolyetherester elastomer comprising 40-65 wt. % of soft segments derived from poly(tetrahydrofuran)diol (pTHF), having a number average molecular weight (Mn) of between 1000 and 2500 kg/kmol.
at least 15 wt % of a metal hydrate.
at least 12.5 wt. % of an oligomeric phosphate ester.

It is surprising that it is possible to produce the composition according to the invention, because normally the metal hydrate decomposes and so releases its water while being mixed with a molten thermoplastic copolyetherester elastomer. However during mixing with the composition of the present invention, comprising the oligomeric phosphate ester, such a decomposition does not take place, so that the metal hydrate keeps its function as a flame retardant.

A thermoplastic elastomer is a rubbery material with the processing characteristics of a conventional thermoplastic and below its melting or softening temperature the performance properties of a conventional thermoset rubber. Thermoplastic elastomers are described in Handbook of Thermoplastic Elastomers, second edition, Van Nostrand Reinhold, New York (ISBN 0-442-29184-1).

The thermoplastic copolyetherester elastomer suitably contains hard segments that are built up from repeating units derived from at least one alkylene diol and at least one aromatic dicarboxylic acid or an ester thereof. As alternative to segment, also the term block is being used. The alkylene diol may be a linear or a cycloaliphatic alkylene diol. The linear or cycloaliphatic alkylene diol contains generally 2-6 C-atoms, preferably 2-4 C-atoms. Examples thereof include ethylene glycol, propylene diol and butylene diol. Preferably propylene diol or butylene diol are used, more preferably 1,4-butylene diol. Examples of suitable aromatic dicarboxylic acids include terephthalic acid, 2,6-naphthalenedicarboxylic acid, 4,4′-biphenyldicarboxylic acid or combinations of these. The hard segments may optionally further contain a minor amount of units derived from other dicarboxylic acids, for example isophthalic acid, which generally lowers the melting point of the polyester. The amount of other dicarboxylic acids is preferably limited to not more than 10 mol %, more preferably not more than 5 mol %, so as to ensure that, among other things, the crystallization behaviour of the copolyetherester is not adversely affected. The hard segment is preferably built up from ethylene terephthalate, propylene terephthalate, and in particular from butylene terephthalate as repeating units. Advantages of these readily available units include favourable crystallisation behaviour and melting point, resulting in copolyetheresters with good processing properties, excellent thermal and chemical resistance

Soft segments of the copolyetherester are derived from poly(tetramethylene oxide)diol or poly(terahydrofuran)diol (pTHF) having a number average molecular weight (Mn) of between 1000 and 2500 kg/kmol. The value for Mn is normally provided by the supplier of the poly(terahydrofuran)diol and may be determined by GPC.

Examples and preparation of copolyetheresters are for example described in Handbook of Thermoplastics, ed. O. Olabishi, Chapter 17, Marcel Dekker Inc., New York 1997, ISBN 0-8247-9797-3, in Thermoplastic Elastomers, 2nd Ed, Chapter 8, Carl Hanser Verlag (1996), ISBN 1-56990-205-4, in Encyclopedia of Polymer Science and Engineering, Vol. 12, Wiley & Sons, New York (1988), ISBN 0-471-80944, p. 75-117, and the references cited therein.

Examples of suitable metal hydrates include magnesium hydroxide, aluminum hydroxide, alumina monohydrate, hydromagnesite, zinc borate hydrate and any combination thereof. Preferably aluminum hydroxide is used.

The composition contains at least 15 wt. %, preferably at least 25 wt. %, more preferably at least 35 wt. %, most preferably at least 45 wt. % of the metal hydrate. The composition according to the invention preferably contains at most 70 wt. %, more preferably at most 65 wt. %, most preferably at most 55 wt. % of the metal hydrate.

Specific examples of suitable oligomeric phosphate esters include resorcinol tetraphenyl diphosphate, bis-phenol A tetraphenyl diphosphate, resorcinol diphosphate, resorcinol diphenyl phosphate (RDP), bisphenol A polyphosphate (BAPP), bisphenol A diphenyl phosphate (BPADP), bisphenol A diphosphate (BADP), (2,6-dimethylphenyl) 1,3-phenylene bisphosphate. Preferably resorcinol diphenyl phosphate (RDP) is used.

The composition according to the invention contains preferably between 15 and 30 wt. % of the oligomeric phosphate ester relative to the total weight of the thermoplastic composition. With this amount of oligomeric phosphate ester very good results are obtained with compounding of the composition and the metal hydrate keeps its function.

The composition according to the invention may suitably comprise one or more additives.

Suitable additives include stabilizers, such as antioxidants, UV-absorbers and heat stabilizers, tougheners, impact modifiers, plasticizers, lubricants, emulsifiers, nucleating agents, fillers, pigments, optical brighteners, further flame retardants, and antistatic agents. Suitable fillers are, for example, calcium carbonate, silicates, talcum, and carbon black.

In a preferred embodiment of the invention the flame retardant thermoplastic composition comprises one or more additives in a total amount of 0.01-20 wt. %, more preferably 0.1-10 wt. %, still more preferably 0.2-5 wt. %, or even 0.5-2 wt. % relative to the total weight of the flame retardant thermoplastic composition.

Preferably the composition according to the invention contains: thermoplastic copolyetherester elastomer comprising 40-65 wt. % of soft segments derived from poly(tetrahydrofuran)diol (pTHF), having a number average molecular weight of between 1000 and 2500 kg/kmol,

15-70 wt. % of a metal hydrate,
12.5-30 wt. % of oligomeric phosphate ester,
0-5 wt. % of one or more additives.

The composition according to the invention is suitably used for the production of insulations of electrical wires and cables and strain relieves of electrical cables.

### EXAMPLES

### Polyetherester:

Polyetherester having 55 wt. % of soft blocks of pTHF having a number average molecular weight of 1000 kg/kmol and hard segments of polybutyleneterephthalate.

### Flame Retardants and Synergists:

ATH: Apyral™ 60 CD, aluminium hydroxide, delivered by Nabaltec from Germany. Flame retardant.

RDP: Fyrolflex™ RDP, resorcinol diphenyl phosphate, ICL Industrial Products from Israel, Synergist.

### Methods:

VW-1: Vertical flame test, UL1581 VW-1.
The value for Mn of poly(tetrahydrofuran)diol has been determined by Size Exclusion Chromatography SEC. Standards of poly(tetrahydrofuran)diol were used to set up a conventional calibration line of Mn as function of retention volume against which the Mn of samples of poly(tetrahydrofuran)diol were measured. SEC equipment Viscotek GPC Max (System ID: LT-5) equipped with Agilent PL MixedE columns and Viscotek Triple Detector Array 302, including ultra-violet (UV), differential refractive index (RI), differential viscometer (DV) and right-angle light-scattering (RALS) detector was used. Poly(tetrahydrofuran)diol samples at concentration 4.5-5.5 mg/ml were eluted with hexafluoroisopropanol solvent at 35° C.

### Sample Preparation:

Compositions were compounded by making a dry blend of the copolyetherester and the flame retardants in a tumbler. The dry blends were fed to and molten in a co-rotating twin screw extruder. After melting and mixing the sample was granulated at the die head of the twin screw extruder. The melt temperature in the extruder was below 215° C., except for comparative experiment B. Thereafter a SVE cable was extruded according to UL 62.

### Examples I-IV and Comparative Experiments A and B

The results of examples I-IV and comparative experiments A and B are given in Table. 1.

The compositions of Examples I-IV, comprising a sufficient amount of RDP, can be compounded without any problems and show a favorable flame retardancy. The composition of comparative experiment B cannot be compounded, because of decomposition of the ATH, as indicated by the occurrence of foaming. This is because the composition of comparative experiment B does not contain any RDP.

TABLE 1

| | poly- | soft | | | | | |
|---|---|---|---|---|---|---|---|
| | mer | block | MWT SB | ATH | RDP | Compouding | |
| example | wt % | wt % | g/mol | wt % | wt % | — | VW-1 |
| I | 33.5 | 55 | 1000 | 40 | 15 | OK | pass |
| II | 38.5 | 55 | 1000 | 40 | 20 | OK | pass |
| III | 43.5 | 55 | 1000 | 40 | 25 | OK | pass |
| IV | 28.5 | 55 | 1000 | 50 | 20 | OK | pass |
| A | 100 | 55 | 1000 | | | na | fail |
| B | 40 | 55 | 1000 | 60 | | NOK; | na |
| | | | | | | foaming | |

1. A polymer composition comprising:
a thermoplastic copolyetherester elastomer comprising 40 65 wt. % of soft segments derived from poly(tetrahydrofuran)diol (pTHF), having a number average molecular weight (Mn) of between 1000 and 2500 kg/kmol.
at least 15 wt % of a metal hydrate,
at least 12.5 wt. % of an oligomeric phosphate ester.

2. A polymer composition according to claim 1, wherein the metal hydrate is aluminium hydroxide.

3. A polymer composition according to claim 1, wherein the composition comprises at most 70 wt. % of the metal hydrate.

4. A polymer composition according to claim 1, wherein the oligomeric phosphate ester is resorcinol diphenyl phosphate (RDP).

5. A polymer composition according to claim 1, wherein the composition comprises 15-30 wt. % of oligomeric phosphate ester.

6. Cable or wire insulation of the polymer composition according to claim 1.

7. Strain relieve for an electrical cable of the polymer composition according to claim 1.
